(19) United States
(12) Patent Application Publication
(10) Pub. No.: US 2018/0154734 A1
(43) Pub. Date: Jun. 7, 2018

(54) WATER COOLED TYPE COOLING-HEATING SYSTEM FOR VEHICLE

(71) Applicants: HYUNDAI MOTOR COMPANY, Seoul (KR); KIA MOTORS CORPORATION, Seoul (KR)

(72) Inventor: Gun Goo Lee, Suwon-si (KR)

(73) Assignees: HYUNDAI MOTOR COMPANY, Seoul (KR); KIA MOTORS CORPORATION, Seoul (KR)

(21) Appl. No.: 15/676,389

(22) Filed: Aug. 14, 2017

(30) Foreign Application Priority Data
Dec. 1, 2016 (KR) 10-2016-0162538

(51) Int. Cl. B60H 1/00

(52) U.S. Cl. CPC B60H 1/00278; B60H 1/00885; B60H 1/00485; B60H 1/00328

(57) ABSTRACT

Disclosed herein is a liquid-cooled cooling-heating system, and methods of using the system, for adjusting the temperature of a battery system and a power electronic component in a vehicle equipped with a high voltage battery comprising: a radiator; a battery heater; a chiller; first and second coolant pumps; first and second three-way valves; a first coolant passage that allows coolant to flow in series from the first three-way valve through the first coolant pump, the battery heater, the battery and back to the first three-way valve; a second coolant passage that allows coolant to flow in series from the first three-way valve, through the radiator, the second three-way valve, the second coolant pump, the power electric component, and back into the first three-way valve; a third coolant passage that branches from the second coolant passage and allows coolant to flow in series through the second three-way valve, the chiller and into the second coolant passage; and a controller that controls operation of the battery heater, the chiller, the coolant pumps, and the valves.

### CROSS REFERENCE TO RELATED APPLICATION

The present application claims benefit of and priority to Korean Patent Application No. 10-2016-0162538, filed on Dec. 1, 2016, the entire contents of which is incorporated herein for all purposes by this reference.

### BACKGROUND

### 1. Technical Field

The present disclosure relates to a liquid-cooled cooling-heating system for an eco-friendly vehicle equipped with a high voltage battery system and methods of using the system, and more particularly, to a liquid-cooled cooling-heating system for adjusting the temperature of a battery system and an electronic power component while a vehicle is driving based on environmental conditions and method of using the system.

### 2. Description of the Related Art

In recent years, eco-friendly vehicles such as a hybrid vehicles having both a fossil fuel-burning engine and an electric motor as a driving source and a vehicle using only an electric motor have been developed and marketed as one of the countermeasures against exhaustion of fossil fuels and environmental pollution.

The eco-friendly vehicle includes a battery for driving the electric motor. Typically, the battery for the eco-friendly vehicle has been a lithium secondary battery as it has high energy density per unit weight. In a conventional eco-friendly vehicle, several pouch-type lithium secondary batteries are connected in series to achieve high output power.

However, when the electric motor battery of the eco-friendly vehicle is used for a long period of time, the battery inevitably experiences an increase in surface temperature and a corresponding reduction in lifetime. Therefore, it is important to manage the temperature of the battery to more efficiently use the battery. To accomplish this, a separate cooling apparatus for cooling a battery of an eco-friendly vehicle may be installed.

Conventional cooling systems for pouch-type lithium secondary batteries include a liquid-cooled system where a plate-type heat exchanger is positioned between the pouch-type batteries and liquid coolant is circulated through the plate-type heat exchanger, and an air-cooled system where outside air is circulated around the pouch-type batteries using a blower.

The matters described as the related art have been provided only for assisting in the understanding for the background of the present disclosure and should not be considered as describing the full scope of related art known to those skilled in the art.

### SUMMARY OF THE DISCLOSURE

An object of the present disclosure is to provide a liquid-cooled cooling-heating system capable of effectively adjusting the temperature of a battery system and a power electric component, thereby increasing driving distance and durability of parts.

According to an example embodiment, a liquid-cooled cooling-heating system for adjusting the temperature of a high voltage battery system and a power electronic component in a vehicle includes: a radiator; a battery heater; a chiller; first and second coolant pumps; first and second three-way valves, each having a first, second and third stage; a first liquid coolant passage that allows a liquid coolant to flow in series from the second stage of the first three-way valve through the first coolant pump, the battery heater, the battery and back to the first stage of the first three-way valve; a second liquid coolant passage that is partially co-extensive with the first liquid coolant passage and allows the liquid coolant to flow in series from the third stage of the first three-way valve, through the radiator, the first stage of the second three-way valve, the third stage of the second three way valve, the second coolant pump, the power electric component, and back into the first stage of the first three-way valve; a third liquid coolant passage that branches from the second liquid coolant passage and allows the liquid coolant to flow in series through the first stage of the second three-way valve, the second stage of the second three-way valve, the chiller and into the second liquid coolant passage; and a controller that controls operation of the battery heater, the chiller, the coolant pumps, and the valves.

The second liquid coolant passage may further include a check valve disposed between the power electronic component and the battery system, such that the liquid coolant may only flow unidirectionally from the power electronic component to the radiator.

When the battery system needs to be cooled, the controller activates the first liquid coolant pump, opens the first stage and the third stage of the first three-way valve, and opens the first stage and the third stage of the second three-way valve. In this configuration, the first liquid coolant pump causes the liquid coolant to flow through the first liquid coolant passage, cooling the battery system. The resulting heated liquid coolant flows into the a portion of the second liquid coolant passage through the first three-way valve, where it is cooled by the radiator and then passes through the second three-way valve back into the first liquid coolant passage to be re-supplied to the battery system.

When the battery system and the power electronic component need to be cooled, the controller activates the first and second liquid coolant pumps, opens the first stage and the third stage of the first three-way valve, and opens the first stage and the third stage of the second three-way valve. In this configuration, the first liquid coolant pump causes the liquid coolant to flow through the first liquid coolant passage, cooling the battery system. The second liquid coolant pump causes the liquid coolant to flow through the second liquid coolant passage, cooling the power electronic component. The resulting heated liquid coolant flows through the first three-way valve into the second liquid coolant passage to be cooled by the radiator and then flows through the second three-way valve back into the first liquid coolant passage where it is re-supplied to the battery system, while also continuing to circulate through the second liquid coolant passage, where it is re-supplied to the power electronic component.

In an alternative embodiment, when the battery system needs to be cooled, the controller activates the first liquid coolant pump and the chiller, opens the first stage and the third stage of the first three-way valve, and opens the first stage and the second stage of the second three-way valve. In this configuration, the first liquid coolant pump causes the liquid coolant to flow through the first liquid coolant passage, cooling the battery system. The resulting heated liquid coolant flows through the first three-way valve into the second liquid coolant passage to be cooled by the radiator, and then flows through the second three-way valve into the third liquid coolant passage, where it is further cooled by the chiller before re-entering the first and second liquid coolant passages, to be re-supplied to the battery system.

In a further alternative embodiment, when the battery system and the power electronic component need to be cooled, the controller activates the first liquid coolant pump, the second liquid coolant pump, and the chiller, opens the first stage and the third stage of the first three-way valve, and opens the first stage and the third stage of the second three-way valve. In this configuration, the first liquid coolant pump causes the liquid coolant to flow through the first liquid coolant passage, cooling the battery system. The second liquid coolant pump causes the liquid coolant to flow through the second liquid coolant passage, cooling the power electronic component. The resulting heated liquid coolant flows through the first three-way valve into the second liquid coolant passage where it is cooled by the radiator. The liquid coolant then flows through the second three-way valve into the third liquid coolant passage and the chiller to be cooled once more, and returns into the first and second liquid coolant passages to be re-supplied to the battery system and the power electronic component.

When the battery system needs to be heated, the controller activates the first liquid coolant pump and the battery heater, and opens the first stage and the second stage of the first three-way valve. In this configuration, the first liquid coolant pump causes the liquid coolant to flow through the first liquid coolant passage and through the activated battery heater, thereby heating the battery system. The liquid coolant then circulates through the first liquid coolant passage, and is re-supplied to the battery heater and the battery system.

When the battery system and the power electronic component need to be simultaneously cooled, after the liquid coolant cooling the battery system and the liquid coolant cooling the power electronic component are merged in the second liquid coolant passage, the liquid coolant cooling the battery system and the liquid coolant cooling the power electronic component may be introduced into the radiator to be cooled and then may be branched into the first liquid coolant pump or the second liquid coolant pump so as to be supplied to the battery system and the power electronic component, respectively.

### BRIEF DESCRIPTION OF THE DRAWINGS

FIG. 1 is a diagram illustrating a liquid-cooled cooling-heating system according to an example embodiment of the present disclosure.

FIG. 2 is a diagram illustrating flow of liquid coolant when only the battery system is cooled by the radiator.

FIG. 3 is a diagram illustrating flow of liquid coolant when the battery system and the power electronic component are simultaneously cooled by the radiator.

FIG. 4 is a diagram illustrating flow of liquid coolant when only the battery system is cooled by the radiator and the chiller.

FIG. 5 is a diagram illustrating flow of liquid coolant when the battery system and the power electronic component are simultaneously cooled by the radiator and the chiller.

FIG. 6 is a diagram illustrating flow of liquid coolant when the battery system is heated by a battery heater.

### DETAILED DESCRIPTION OF THE EXAMPLE EMBODIMENTS

Hereinafter, a liquid-cooled cooling-heating system according to an example embodiment of the present disclosure is described with reference to the accompanying drawings.

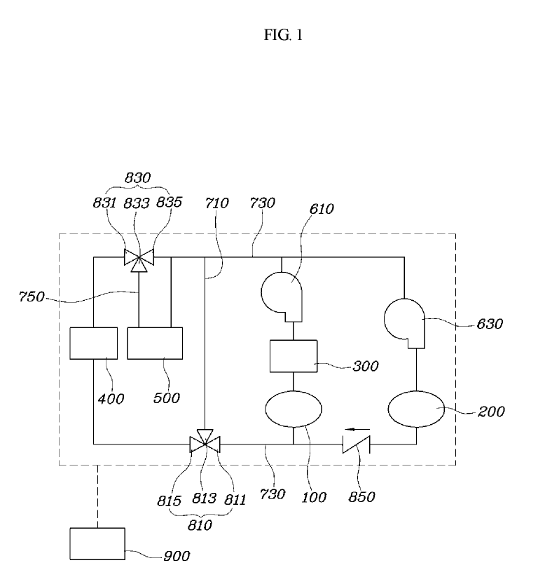

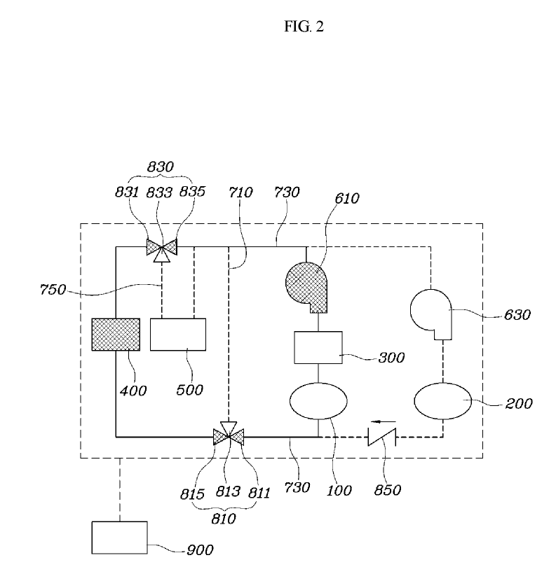

FIG. 1 is a diagram illustrating a liquid-cooled cooling-heating system according to an example embodiment of the present disclosure and FIGS. 2 to 6 are diagrams illustrating control of liquid coolant flow to cool or heat various components of the battery system.

As illustrated in FIG. 1, according to an example embodiment of the present disclosure, a liquid-cooled cooling-heating system for cooling or heating a battery system 100 and cooling a power electronic component 200, in a vehicle equipped with a high voltage battery includes: a radiator 400; a battery heater 300; a chiller 500; first and second liquid coolant pumps 610 and 630; first and second three-way valves 810 and 830, each having a first, second and third stage (811, 813, and 815 for the first three-way valve and 831, 833, and 835 for the second three-way valve); a first liquid coolant passage 710 for circulating coolant extending, in series, through a first liquid coolant pump 610 that allows liquid coolant to flow in series from second stage 813 of first three-way valve 810 through first liquid coolant pump 610, battery heater 300, battery system 100 and back to first stage 811 of first three-way valve 810; a second liquid coolant passage 730 that is partially co-extensive with first coolant passage 710 and allows coolant to flow in series from third stage 815 of first three-way valve 810, through radiator 400, first stage 831 of second three-way valve 830, third stage 835 of second three-way valve 830, second coolant pump 630, power electric component 200, and back into first stage 811 of first three-way valve 810; a third liquid coolant passage 750 branched from second liquid coolant passage 730 that allows the liquid coolant to flow through second stage 833 of second three-way valve 830 and chiller 500 back into second liquid coolant passage 730; and a controller 900 that separately controls the operation of first liquid coolant pump 610, second liquid coolant pump 630, battery heater 300, and chiller 500 and the opening and closing of first three-way valve 810 and second three-way valve 830.

Second liquid coolant passage 730 may further comprise a check valve 850 disposed between the power electronic component 200 and the battery system 100, that ensures the liquid coolant may move only unidirectionally from power electronic component 200 to radiator 400 and does not backflow into power electronic component 200.

The liquid-cooled cooling-heating system according to the example embodiment of the present disclosure will be separately described in each case with reference to the accompanying drawings.

FIG. 2 is a diagram illustrating the flow of liquid coolant when only battery system 100 is cooled by radiator 400. When battery system 100 needs to be cooled due to driving of a vehicle, or the like, controller 900 activates first liquid coolant pump 610 and opens first stage 811 and third stage 815 of first three-way valve 815 and first stage 831 and third stage 835 of second three-way valve 830. Therefore, one closed loop consisting of first liquid coolant passage 710, first liquid coolant pump 610, battery heater 300, battery system 100, a portion of second liquid coolant passage 730, first three-way valve 810, radiator 400, and second three-way valve 830 is formed, such that liquid coolant is repeatedly circulated in the closed loop.

First, first liquid coolant pump 610 causes liquid coolant to flow through first liquid coolant passage 710 and through battery heater 300. Because battery heater 300 is not activated, it has no effect on the liquid coolant temperature. Liquid coolant passing through battery heater 300 is introduced into battery system 100 to cool and/or heat battery system 100. When the heated liquid coolant exits battery system 100 and flows into a co-extensive portion of first and second liquid coolant passages 710 and 730, it proceeds into first stage 811 of first three-way valve 810, is discharged through third stage 815, and is introduced into radiator 400 to be cooled. After being cooled in radiator 400, the liquid coolant is introduced into first stage 831 of second three-way valve 830, is discharged through third stage 835, and then flows through the first liquid coolant pump 610 again to be re-supplied to battery system 100. Liquid coolant is thereby repeatedly circulated in the closed loop providing continuous cooling to battery system 100.

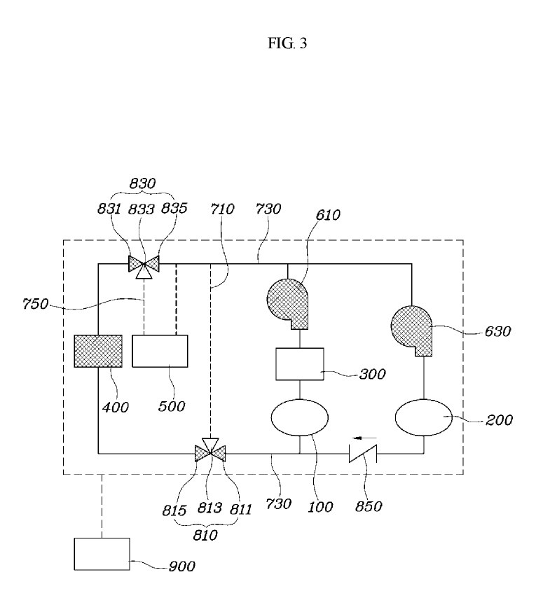

FIG. 3 is a diagram illustrating a flow of liquid coolant when battery system 100 and power electronic component 200 are simultaneously cooled by radiator 400. When battery system 100 and power electronic component 200 need to be cooled due to driving of a vehicle, or the like, controller 900 activates first liquid coolant pump 610 and second liquid coolant pump 630 and opens first stage 811 and third stage 815 of first three-way valve 810 and first stage 831 and third stage 835 of second three-way valve 830.

To simultaneously cool both battery system 100 and power electronic component 200, first, as illustrated in FIG. 2, one closed loop consisting of first liquid coolant pump 610, battery heater 300, battery system 100, a portion of second liquid coolant passage 730, first three-way valve 810, radiator 400, and the second three-way valve 830 is formed, such that liquid coolant is repeatedly circulated in the closed loop. Second liquid coolant pump 630, power electronic component 200 and the check valve 850 are disposed along second liquid coolant passage 730 in parallel with and connected to the closed loop so as to form a separate closed loop sharing first three-way valve 810, second three-way valve 830, and radiator 400, such that the liquid coolant is repeatedly circulated in the separate closed loop.

As described above, when battery system 100 and power electronic component 200 are simultaneously cooled, after the liquid coolant cooling battery system 100 and the liquid coolant cooling power electronic component 200 are merged in a co-extensive portion of the first and second liquid coolant passages 710 and 730, liquid coolant cooling battery system 100 and liquid coolant cooling power electronic component 200 pass through first three-way valve 810, are cooled in radiator 400, pass through second three-way valve 830, and branch into first liquid coolant pump 610 or second liquid coolant pump 630 to thereby be supplied to battery system 100 and power electronic component 200, respectively.

The flow of the liquid coolant is described below.

First, in the closed loop cooling battery system 100, first liquid coolant pump 610 causes liquid coolant to flow in first liquid coolant passage 710 through battery heater 300. Because battery heater 300 is not activated, it has no effect on the temperature of the liquid coolant. Liquid coolant passing through battery heater 300 is introduced into battery system 100 to adjust the temperature of battery system 100. When the heated liquid coolant exiting battery system 100 flows in a co-extensive portion of first and second liquid coolant passages 710 and 730, the heated liquid coolant is then introduced into first stage 811 of first three-way valve 810, discharged through third stage 815, and then cooled in radiator 400. Liquid coolant exiting radiator 400 flows in second liquid coolant passage 730 to first stage 831 of second three-way valve 830, is discharged through third stage 835, and then flows through first liquid coolant pump 610 again to be re-supplied to battery system 100, thereby repeatedly circulating in a closed loop and continuously cooling battery system 100.

Next, describing the cooling path for power electronic component 200, second liquid coolant pump 630 causes liquid coolant to flow through second liquid coolant passage 730 into power electronic component 200 to adjust the temperature of power electronic component 200. When heated liquid coolant exiting power electronic component 200 flows in second liquid coolant passage 730, it passes through check valve 850 and then is introduced into first stage 811 of first three-way valve 810. The heated liquid coolant is discharged through third stage 815 and is cooled in radiator 400. Liquid coolant exiting radiator 400 flows through second liquid coolant passage 730 into first stage 831 of second three-way valve 830, is discharged through third stage 835, and then flows through the second liquid coolant pump 630 again to be re-supplied to power electronic component 200, thereby repeatedly circulating in a closed loop and continuously cooling power electronic component 200.

Further, as described above, when battery system 100 and power electronic component 200 are simultaneously cooled, after liquid coolant cooling battery system 100 and liquid coolant cooling power electronic component 200 are merged in a co-extensive portion of first and second liquid coolant passages 710 and 730, the combined liquid coolant flows through first three-way valve 810, the radiator 400, and second three-way valve 830, and then are again branched into first liquid coolant pump 610 and second liquid coolant pump 630.

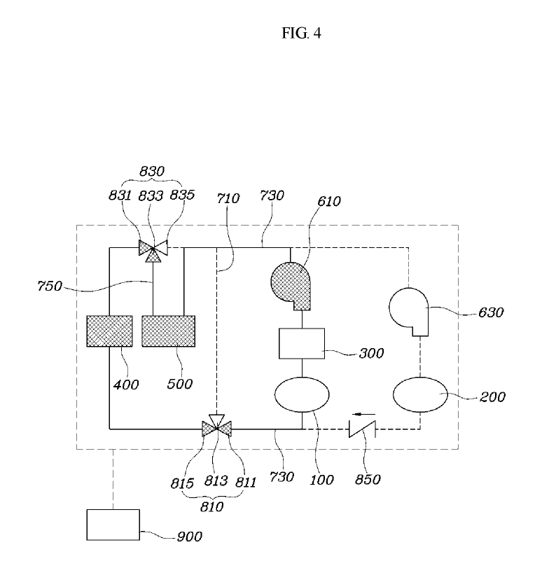

FIG. 4 is a diagram illustrating the flow of liquid coolant when only battery system 100 is cooled by radiator 400 and chiller 500. When battery system 100 needs to be cooled more powerfully than in the situation of FIG. 2 due to driving of a vehicle, or the like in a high-temperature environment (e.g. summer, equatorial regions, desert conditions, etc.), controller 900 activates first liquid coolant pump 610 and chiller 500 and opens first stage 811 and third stage 815 of first three-way valve 810 and first stage 831 and second stage 833 of second three-way valve 830. Therefore, one closed loop consisting of first liquid coolant pump 610, battery heater 300, battery system 100, a portion of second liquid coolant passage 730, first three-way valve 810, radiator 400, second three-way valve 830, third liquid coolant passage 750, and chiller 500 is formed, such that the liquid coolant is repeatedly circulated in the closed loop.

First liquid coolant pump 610 causes liquid coolant to flow in first liquid coolant passage 710 through battery heater 300. Because battery heater 300 is not activated, it has no effect on the temperature of the liquid coolant. Liquid coolant passing through battery heater 300 flows into and adjusts the temperature of battery system 100. Heated liquid coolant exiting battery system 100 flows into a co-extensive portion of first and second liquid coolant passages 710 and 730, is introduced into first stage 811 of first three-way valve 810, is discharged through third stage 815, and cooled in radiator 400. Liquid coolant exiting radiator 400 flows through second liquid coolant passage 730, is introduced into first stage 831 of second three-way valve 830, is discharged through second stage 833, and introduced into third liquid coolant passage 750. Third liquid coolant passage 750 passes through chiller 500, and therefore liquid coolant exiting radiator 400 flows through chiller 500 to be further cooled and returns to first and second liquid coolant passages 710 and 730 to reenter first liquid coolant pump 610 and be resupplied to battery system 100, thereby repeatedly circulating in a closed loop and continuously cooling battery system 100.

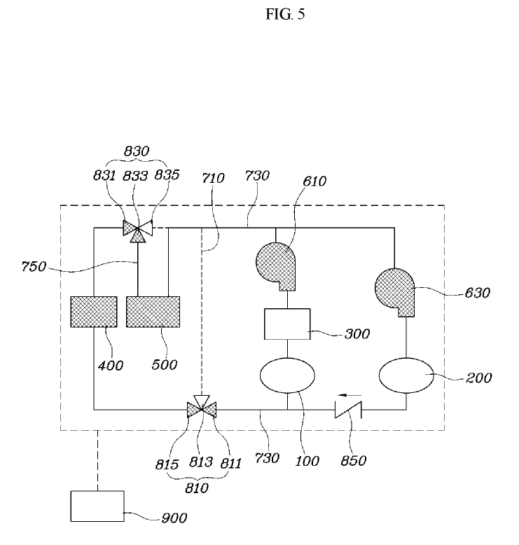

FIG. 5 is a diagram illustrating the flow of liquid coolant when battery system 100 and power electronic component 200 are simultaneously cooled by radiator 400 and chiller 500. When battery system 100 and power electronic component 200 need to be cooled more powerfully than in the situation of FIG. 3 due to driving of a vehicle, or the like, in high temperature conditions such as those described above, controller 900 activates first liquid coolant pump 610, second liquid coolant pump 630, and chiller 500 and opens first stage 811 and third stage 815 of first three-way valve 810 and first stage 831 and second stage 833 of second three-way valve 830.

To simultaneously cool both battery system 100 and power electronic component 200, as illustrated in FIG. 4, one closed loop consisting of first liquid coolant pump 610, battery heater 300, battery system 100, a portion of second liquid coolant passage 730, first three-way valve 810, radiator 400, second three-way valve 830, third liquid coolant passage 775, and chiller 500 is formed, such that liquid coolant is repeatedly circulated in the closed loop. A second closed loop is formed in parallel to the first by second liquid coolant pump 630, power electronic component 200, check valve 850 and shared components including first three-way valve 810, second three-way valve 830, radiator 400, and chiller 500, such that the liquid coolant is repeatedly circulated in the second closed loop.

As described above, when battery system 100 and power electronic component 200 are simultaneously cooled, after the liquid coolant cooling battery system 100 and the liquid coolant cooling power electronic component 200 are merged in a co-extensive region of first and second liquid coolant passages 710 and 730, the merged stream passes through first three-way valve 810 and is cooled by radiator 400. The liquid coolant exiting radiator 400 flows through second liquid coolant passage 730 into second three-way valve 830, where it is then diverted into third liquid coolant passage 750 and further cooled in chiller 500 before rejoining first and second liquid coolant passages 710 and 730 and branching into first liquid coolant pump 610 or second liquid coolant pump 630 to thereby be re-supplied to battery system 100 and power electronic component 200, respectively.

The flow of the liquid coolant in this configuration is described below.

First, with respect to battery system 100, first liquid coolant pump 610 causes liquid coolant to flow through first liquid coolant passage into battery heater 300. Because battery heater 300 is not activated, it has no effect on the temperature of the liquid coolant. Liquid coolant passing through battery heater 300 is introduced into and adjusts the temperature of battery system 100. After heated liquid coolant exiting battery system 100 flows through a co-extensive portion of first and second liquid coolant passages 710 and 730, heated liquid coolant is introduced into first stage 811 of first three-way valve 810, is discharged through third stage 815, and is cooled by radiator 400. Liquid coolant exiting radiator 400 flows through second liquid coolant passage 730, is introduced into first stage 831 of second three-way valve 830, and is discharged through second stage 833 into third liquid coolant passage 750, where it is further cooled by chiller 500. The cooled liquid coolant passes through first liquid coolant pump 610 to be re-supplied to battery system 100, thereby repeatedly circulating in the closed loop and continuously cooling battery system 100.

Next, describing the cooling path for power electronic component 200, second liquid coolant pump 630 causes liquid coolant to flow through second liquid coolant passage 730 into power electronic component 200 to adjust the temperature of power electronic component 200. Heated liquid coolant leaving power electronic component 200 flows through check valve 850 and then is introduced into first stage 811 of first three-way valve 810, is discharged through third stage 815 and cooled in radiator 400. On exiting radiator 400, the liquid coolant flows through second liquid coolant passage 730, is introduced into first stage 831 of second three-way valve 830, is discharged through second stage 833, and introduced into third liquid coolant passage 750, where it is then further cooled by chiller 500. The liquid coolant then returns to the first and second fluid coolant passages 710 and 730 to pass through second liquid coolant pump 630 and be re-supplied to power electronic component 200, thereby repeatedly circulating in the closed loop and continuously cooling power electronic component 200.

Further, as described above, when battery system 100 and power electronic component 200 are simultaneously cooled, after the liquid coolant cooling battery system 100 and the liquid coolant cooling power electronic component 200 are merged in a co-extensive region of first and second liquid coolant passages 710 and 730, the combined stream passes through first three-way valve 810, radiator 400, second three-way valve 830, third liquid coolant passage 750, the chiller 500, and return to first and second liquid coolant passages 710 and 730 where it is again branched into first liquid coolant pump 610 and second liquid coolant pump 630.

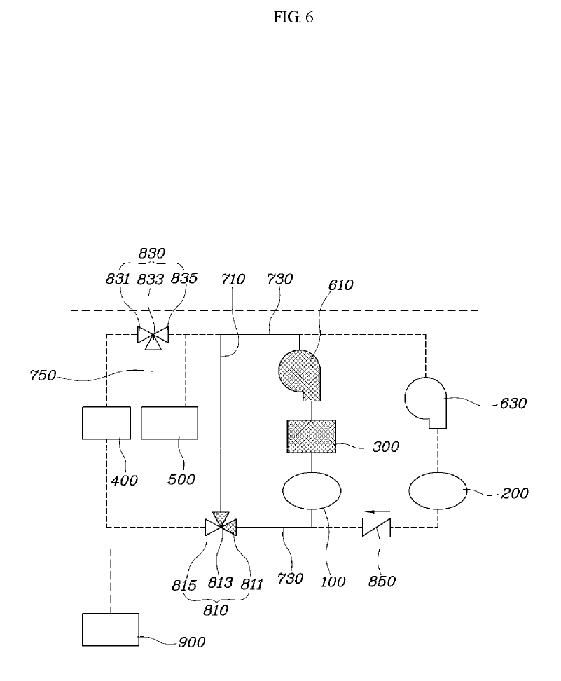

FIG. 6 is a diagram illustrating the flow of liquid coolant when only battery system 100 is heated by battery heater 300. When battery system 100 needs to be heated due to driving of a vehicle, or the like, in low temperature conditions (e.g. winter), controller 900 activates first liquid coolant pump 610 and battery heater 300 and opens first stage 811 and second stage 813 of first three-way valve 810. Therefore, a closed loop consisting of first liquid coolant pump 610, battery heater 300, battery system 100, first liquid coolant passage 710, and first three-way valve 810 is formed, such that liquid coolant is repeatedly circulated in the closed loop.

First, first liquid coolant pump 610 causes liquid coolant to flow through first liquid coolant passage 710 and into battery heater 300, where, because battery heater 300 is now activated, the liquid coolant is heated. The liquid coolant heated by passing through battery heater 300 is introduced into and heats battery system 100. Liquid coolant discharged from battery system 100 flows in first liquid coolant passage 710, is introduced into first stage 811 of first three-way valve 810, is discharged to second stage 813, and then flows through first liquid coolant pump 610 and battery heater 300 again to be re-supplied to battery system 100, thereby repeatedly circulating in the closed loop and continuously heating battery system 100.

The liquid-cooled cooling-heating system according to the example embodiments as described above may be particularly useful in eco-friendly vehicles equipped with the high voltage battery system. The present disclosure relates to a layout for components involved in adjusting the temperature of battery system 100 and power electronic component 200 in the eco-friendly vehicles. Here, when battery system 100 and power electronic component 200 need to be cooled during driving of the vehicle or during the summer, only the radiator 400 and/or the chiller 500 are activated based on the environment of the vehicle to cool battery system 100 and power electronic component 200. When battery system 100 needs to be heated during winter, battery heater 300 is activated to heat the liquid coolant thereby heating battery system 100. The three-way valves are selectively opened and closed as needed to supply liquid coolant to the appropriate components based on the environmental condition of the vehicle.

Therefore, using the liquid-cooled cooling-heating system according to the example embodiments of the present invention, it is possible to increase the driving distance of the vehicle and increase the durability of the vehicle's parts by selectively and efficiently cooling or heating of battery system 100 and power electronic component 200.

Although the present disclosure has described specific example embodiments, it will be obvious to those skilled in the art that the present disclosure may be variously modified and altered without departing from the spirit and scope of the invention as defined by the following claims.

What is claimed is:

1. A liquid-cooled system for adjusting the temperature of a battery system and a power electronic component in a vehicle equipped with a high voltage battery, the system comprising
a radiator;
a battery heater;
a chiller;
first and second liquid coolant pumps;
first and second three-way valves, each having a first, second and third stage;
a first liquid coolant passage that allows liquid coolant to flow in series from the second stage of the first three-way valve through the first coolant pump, the battery heater, the battery and back to the first stage of the first three-way valve;
a second liquid coolant passage that is partially co-extensive with the first liquid coolant passage and allows the liquid coolant to flow in series from the third stage of the first three-way valve, through the radiator, the first stage of the second three-way valve, the third stage of the second three way valve, the second coolant pump, the power electric component, and back into the first stage of the first three-way valve;
a third liquid coolant passage that branches from the second liquid coolant passage and allows the liquid coolant to flow in series through the first stage of the second three-way valve, the second stage of the second three-way valve, the chiller and back into the second liquid coolant passage; and
a controller that controls operation of the battery heater, the chiller, the coolant pumps, and the valves.

2. The liquid-cooled type cooling-heating system of claim 1, further comprising a check valve disposed along the second liquid coolant passage between the power electronic component and the battery system, wherein the check valve prevents backflow of the liquid coolant into the power electronic component.

3. The liquid-cooled cooling-heating system of claim 1, wherein the liquid coolant is water.

4. A method of cooling a battery system using the liquid-cooled cooling-heating system of claim 1, wherein when the battery system needs to be cooled, the controller activates the first liquid coolant pump and opens the first stage and the third stage of the first three-way valve and the first stage and the third stage of the second three-way valve.

5. A method of cooling a battery system and a power electronic component using the liquid-cooled cooling-heating system of claim 1, wherein when the battery system and the power electronic component need to be cooled, the controller activates the first liquid coolant pump and the second liquid coolant pump and opens the first stage and the third stage of the first three-way valve and the first stage and the third stage of the second three-way valve.

6. A method of cooling a battery system using the liquid-cooled cooling-heating system of claim 1, wherein when the battery system needs to be cooled, the controller activates the first liquid coolant pump and the chiller and opens the first stage and the third stage of the first three-way valve and the first stage and the second stage of the second three-way valve.

7. A method of cooling a battery system and a power electronic component using the liquid-cooled cooling-heating system of claim 1, wherein when the battery system and the power electronic component need to be cooled, the controller activates the first liquid coolant pump, the second liquid coolant pump, and the chiller and opens the first stage and the third stage of the first three-way valve and the first stage and the third stage of the second three-way valve.

8. A method of heating a battery system using the liquid-cooled cooling-heating system of claim 1, wherein when the battery system needs to be heated, the controller activates the first liquid coolant pump and the battery heater and opens the first stage and the second stage of the first three-way valve.
